(19) United States
(12) Patent Application Publication
(10) Pub. No.: US 2015/0233298 A1
(43) Pub. Date: Aug. 20, 2015

(54) REDUCTION IN JET FLAP INTERACTION NOISE WITH GEARED TURBINE ENGINE

(71) Applicant: UNITED TECHNOLOGIES CORPORATION, Hartford, CT (US)

(72) Inventor: Constantine Baltas, Manchester, CT (US)

(21) Appl. No.: 14/428,392

(22) PCT Filed: Feb. 22, 2013
(86) PCT No.: PCT/US2013/027263

§ 371 Date: Mar. 16, 2015

Related U.S. Application Data
(60) Provisional application No. 61/706,889, filed on Sep. 28, 2012.

(51) Int. Cl. F02C 7/24; F02C 3/107; F02K 1/34

(52) U.S. Cl. CPC F02C 7/24; B64D 33/06; F02C 3/107

(57) ABSTRACT

A turbine engine system mounted on an aircraft wing includes a gas turbine engine having a spool, a turbine coupled with the spool, a fan coupled to be rotated about an axis through the spool, and a gear assembly coupled between the fan and spool such that rotation of the spool results in rotation of the fan at a different speed than the spool. The gas turbine engine is operable to discharge a jet plume that interacts with a flap of the aircraft wing. The gas turbine engine defines a design fan pressure ratio of 1.25-1.50 to control sound resulting from the jet plume that interacts with the flap.

### CROSS REFERENCE TO RELATED APPLICATION

This application claims priority to U.S. Provisional Application No. 61/706,889, which was filed 28 Sep. 2012 and is incorporated herein by reference.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

### SUMMARY

A turbine engine system according to an exemplary aspect of the present disclosure includes a gas turbine engine and also includes a spool, a turbine coupled with the spool, a fan coupled to be rotated about an axis through the spool, and a gear assembly coupled between the fan and the spool such that rotation of the spool results in rotation of the fan at a different speed than the spool. The gas turbine engine is situated near an aircraft wing and is operable to discharge a jet plume that interacts with a flap of the aircraft wing, and the gas turbine engine defines a design fan pressure ratio of 1.25-1.50 to control sound results from the jet plume that interacts with the flap.

In a further non-limiting embodiment of any of the foregoing examples, the gear assembly has a gear reduction ratio greater than 2.3:1.

In a further non-limiting embodiment of any of the foregoing examples, the turbine has a maximum rotor diameter and the fan has a fan diameter such that a ratio of the maximum rotor diameter divided by the fan diameter is less than 0.6.

In a further non-limiting embodiment of any of the foregoing examples, the gas turbine engine has a design bypass ratio that is greater than 6.

In a further non-limiting embodiment of any of the foregoing examples, the gas turbine engine has a design bypass ratio that is greater than 10.

In a further non-limiting embodiment of any of the foregoing examples, the method comprising of reducing sound generated from interaction between a jet plume of a gas turbine engine and a flap of an aircraft wing by configuring the gas turbine engine with a design fan pressure ratio of 1.25-1.50.

In a further non-limiting embodiment of any of the foregoing examples, includes reducing the sound generated at an aircraft speed of a Mach number of 0.1-0.3.

In a further non-limiting embodiment of any of the foregoing examples, the gas turbine engine includes a spool, a turbine coupled with the spool, a fan coupled to be rotated about an axis through the spool, and a gear assembly coupled between the fan and the spool such that rotation of the spool results in rotation of the fan at a different speed than the spool, the gear assembly having a gear reduction ratio greater than 2.3:1.

In a further non-limiting embodiment of any of the foregoing examples, the turbine has a maximum rotor diameter and the fan has a fan diameter such that a ratio of the maximum rotor diameter divided by the fan diameter is less than 0.6.

In a further non-limiting embodiment of any of the foregoing examples, the gas turbine engine has a design bypass ratio that is greater than 6.

In a further non-limiting embodiment of any of the foregoing examples, the gas turbine engine has a design bypass ratio that is greater than 10.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates the gas turbine engine mounted on a wing of an aircraft.

FIG. 3 illustrates a cross-section of a jet plume interacting with a flap of a wing.

### DETAILED DESCRIPTION

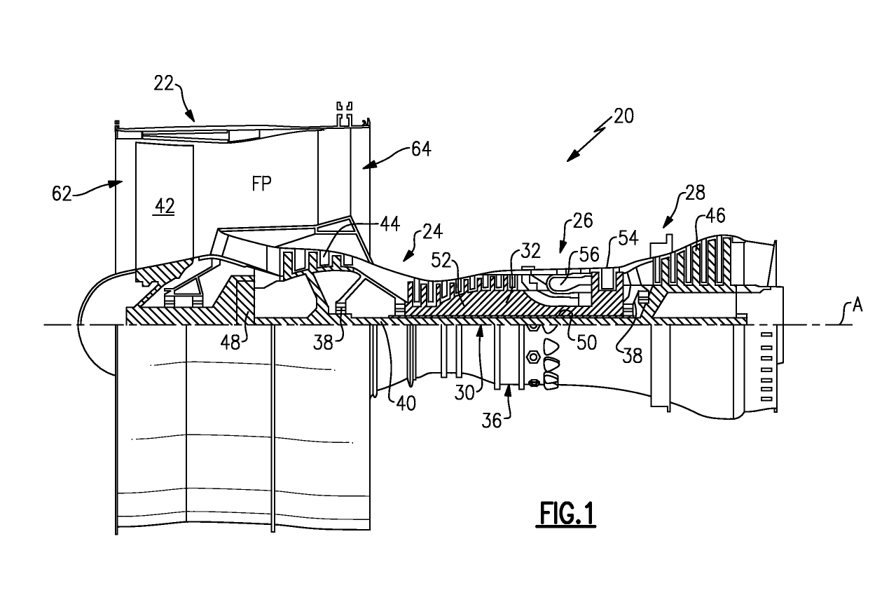

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines, including three-spool architectures.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

The core airflow is compressed by the first compressor 44 then the second compressor 52, mixed and burned with fuel in the annular combustor 56, then expanded over the second turbine 54 and first turbine 46. The first turbine 46 and the second turbine 54 rotationally drive, respectively, the first spool 30 and the second spool 32 in response to the expansion.

The engine 20 is a high-bypass geared aircraft engine that has a design bypass ratio that is greater than about six (6), with an example embodiment being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about 5. The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

Engine jet plume interaction with aircraft wing flaps can be a source of jet noise (i.e., Jet Flap Interaction or “JFI”). JFI can depend on the aircraft and the engine installation and may vary widely among aircraft. The JFI noise source level changes with the flight condition and depends on lift augmentation and flap setting requirements.

Since JFI is primarily due to an engine installation, which in turn is the result of design iterations satisfying aircraft operational and safety criteria, there is little freedom for design compromise and change to a more optimal engine/aircraft integration is often prohibited. Additionally, given that an engine design is fixed and the jet plume flow characteristics constant at each flight condition, the only changes possible will be geometric and minor. The effect of those minor changes has an insignificant impact on JFI noise.

An effective way to reduce JFI without imposing restrictions on the aircraft is to address the main source of noise, the engine. For example, the noise can be reduced by reducing the jet plume velocity.

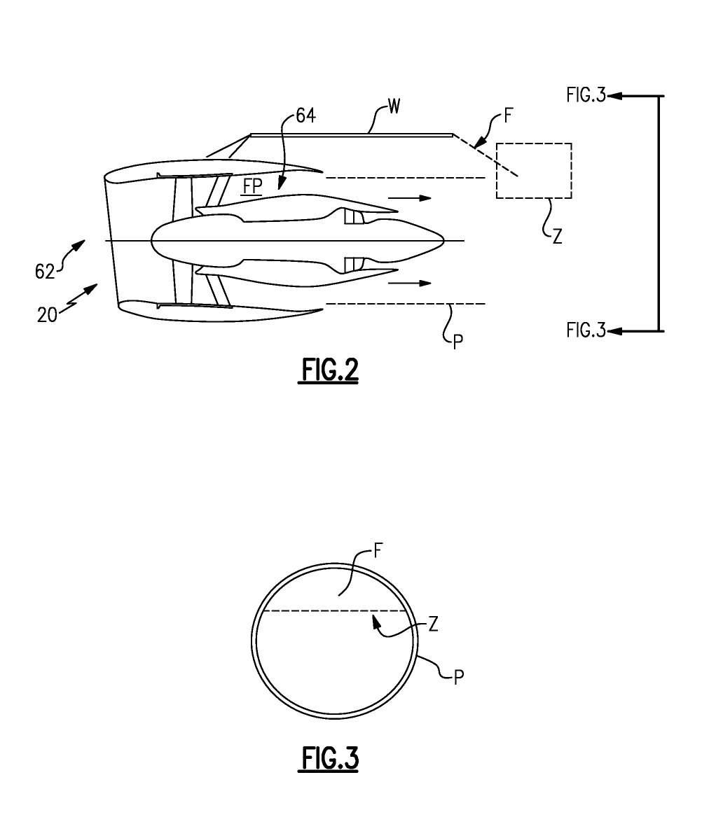

Referring to FIG. 2 and FIG. 3, the engine 20 (a geared turbine engine) is situated on a wing W such that in operation its jet plume P interacts with a flap F of the wing W. The engine 20 can be mounted on a pylon of the wing W in a known manner. For example, at least a portion of a cross-sectional profile of the jet plume P overlaps at least one flap of the wing W, as shown in jet flap interaction zone Z. The engine 20, situated in such a location on the wing W, reduces JTI noise by using a low jet plume velocity and a low design fan pressure ratio.

The design fan pressure ratio is taken with respect to an inlet pressure at an inlet 62 of the engine 20 and an outlet pressure at an outlet 64 of the fan bypass flow path FP of the engine 20. As an example, the design pressure ratio can be determined based upon the stagnation inlet pressure and the stagnation outlet pressure at a design rotational speed of the engine 20, such as at cruise.

In a further example, the JTI noise is controlled, reduced or modulated under one or more conditions including: an aircraft Mach number of 0.1-0.3, the design fan pressure ratio is 1.25-1.50, the engine 20 includes the fan drive gear system 48, the jet plume P spans 100% of the flap F trailing edge (FIG. 3), and the jet plume P interacts with 100% of the flap F trailing edge (FIG. 3).

A method of controlling JTI noise includes reducing sound generated from interaction between the jet plume P and the flap F by configuring the gas turbine engine 20 with a design fan pressure ratio of 1.25-1.50. As described, the design fan pressure ratio can be provided by the use of the fan drive gear system 48.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A turbine engine system mounted on an aircraft wing, comprising:
a gas turbine engine including a spool, a turbine coupled with the spool, a fan coupled to be rotated about an axis through the spool, and a gear assembly coupled between the fan and the spool such that rotation of the spool results in rotation of the fan at a different speed than the spool,
the gas turbine engine being operable to discharge a jet plume that interacts with a flap of the aircraft wing, and
the gas turbine engine defining a design fan pressure ratio of 1.25-1.50 to control sound resulting from the jet plume that interacts with the flap.

2. The turbine engine system as recited in claim 1, wherein the gear assembly has a gear reduction ratio greater than 2.3:1.

3. The turbine engine system as recited in claim 1, wherein the turbine has a maximum rotor diameter and the fan has a fan diameter such that a ratio of the maximum rotor diameter divided by the fan diameter is less than 0.6.

4. The turbine engine system as recited in claim 1, wherein the gas turbine engine has a design bypass ratio that is greater than 6.

5. The gas turbine engine system as recited in claim 1, wherein the gas turbine engine has a design bypass ratio that is greater than 10.

6. A method of controlling sound in a turbine engine system, the method comprising:
reducing sound generated from interaction between a jet plume of a gas turbine engine and a flap of an aircraft wing by configuring the gas turbine engine with a design fan pressure ratio of 1.25-1.50.

7. The method as recited in claim 6, including reducing the sound generated at an aircraft speed of a Mach number of 0.1-0.3.

8. The method as recited in claim 6, wherein the gas turbine engine includes a spool, a turbine coupled with the spool, a fan coupled to be rotated about an axis through the spool, and a gear assembly coupled between the fan and the spool such that rotation of the spool results in rotation of the fan at a different speed than the spool, the gear assembly having a gear reduction ratio greater than 2.3:1.

9. The method as recited in claim 8, wherein the turbine has a maximum rotor diameter and the fan has a fan diameter such that a ratio of the maximum rotor diameter divided by the fan diameter is less than 0.6.

10. The method as recited in claim 6, wherein the gas turbine engine has a design bypass ratio that is greater than 6.

11. The method as recited in claim 6, wherein the gas turbine engine has a design bypass ratio that is greater than 10.
